(19) United States
(12) Patent Application Publication
(10) Pub. No.: US 2002/0174424 A1
(43) Pub. Date: Nov. 21, 2002

(54) Apparatus and method for providing an indication of program(s) and/or activities

(76) Inventors: Matthew S. Chang, San Diego, CA (US); Aditya Krishnan, San Diego, CA (US); Andrew M. Proehl, San Francisco, CA (US); David K.L. Yang, San Jose, CA (US); Frederick J. Zustak, Poway, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: FROMMER, LAWRENCE & HAUG LLP, 745 FIFTH AVENUE, NEW YORK, NY, 10151, US

(21) Appl. No.: 09/862,402

(22) Filed: May 21, 2001

(51) Int. Cl. H04N 7/173; H04N 7/16

(52) U.S. Cl. 725/9; 725/10; 725/68; 725/110

(57) ABSTRACT

An apparatus and method for providing indications of items such as a television program or programs watched by user, television program or programs to be watched by the user, an activity or activities in which the user has participated, and an activity or activities the user is scheduled to participated. The apparatus comprises an input device which obtains information regarding at least one of a television program or programs watched by the user, television program or programs to be watched by the user, an activity or activities in which the user has participated, and an activity or activities the user is scheduled to participated; a processor arranged to receive the obtained information which produces a program/activity signal representative of each television program or activity arranged in a predetermined manner; and an output interface which enables the program/activity signal to be supplied to at least one television unit located at a location remote from the apparatus so as to enable an indication of each the television program and activity to be displayed thereon in the predetermined manner.

### BACKGROUND OF THE INVENTION

The present invention relates to an apparatus and method for providing an indication of programs and/or activities pertaining to a user and, more particularly, to such apparatus and method which provides an indication of television programs watched and/or to be watched by a user, activities performed and/or to be performed by the user, and so forth for display on a display device.

Today, due to busy schedules, people often do not have time to write or telephone family members or friends regarding day to day events such as television programs they watched or are planning to watch, activities such as sporting events and the like in which they have participated or are scheduled to participate, and so forth. As a result, people may not share comments pertaining to such television program(s) or activities with other family members or friends.

Similarly, due to their busy or conflicting schedules, family members within a household may be unable to watch television programs together. As such, children may watch television programs without their parents. Accordingly, parents may not know what programs their children have watched.

### OBJECTS AND SUMMARY OF THE INVENTION

It is an object of the present invention to provide an apparatus and method which enables one or more family members or friends to easily inform others as to television programs they watched and/or are planning to watch.

Another object of the present invention is to provide an apparatus and method which enables parents to know what television programs their children have watched.

A further object of the present invention is to provide an apparatus and method which enables a person to easily provide other people with a schedule or listing of activities in which he or she will participate and/or has already participated.

A yet further object of the present invention is to provide an apparatus and method as aforesaid wherein the television programs and/or the activities are available for display on a display unit in a predetermined format.

A still further object of the present invention is to provide an apparatus and method as aforesaid which enables a user to insert comments into the display of the television programs and/or activities.

An aspect of the present invention is to provide a television program apparatus comprising a device for obtaining information regarding a number of television programs watched by a viewer, a circuit for producing a viewer program signal representative of each television program watched by the user arranged in a predetermined manner, and a device adapted to be coupled to a television unit for enabling the viewer program signal to be supplied to the television unit so as to enable an indication of each the television program watched by the viewer to be displayed thereon in the predetermined manner.

The above and other objects, features and advantages according to the present invention will be apparent from the following detailed description of the illustrated embodiments when read in conjunction with the accompanying drawings in which corresponding components are identified by the same reference numerals.

### BRIEF DESCRIPTION OF THE DRAWINGS

FIG. 1 is a system block diagram of a system using a set-top box;

FIG. 2 is a functional block diagram of a digital set-top box suitable for use with the present invention;

FIG. 3 is a diagram of a television program system according to an embodiment of the present invention;

FIGS. 4-6 are diagrams of formats for displaying television programs and/or activities; and

FIG. 7 is a diagram to which reference will be made in describing different levels of accessibility for the present invention.

### DETAILED DESCRIPTION OF PREFERRED EMBODIMENTS

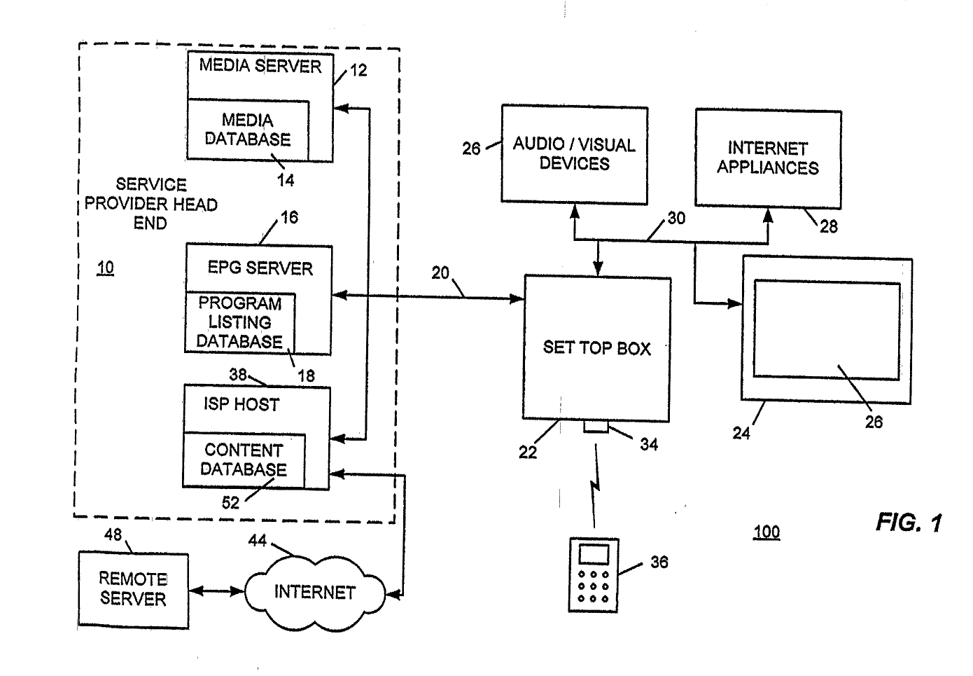

The preferred embodiments of the present invention will be described with reference to the accompanying drawings. Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bi-directional communication over a transmission medium 20 in the case of a cable STB 22. In other embodiments, bi-directional communication can be effected using asymmetrical communication techniques possibly using dual communication media--one for the uplink and one for the downlink. In any event, the STB 22 can have its own Universal Resource Locator (URL) assigned thereto to provide for addressability by the head end and users of the Internet.

The media server 12 and EPG server 16 are coupled by transmission medium 20 to set top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB.

The exemplary system 100 further includes a TV 24, such as a digital television, having a display 26 for displaying programming, an EPG, etc. The STB 22 may be coupled to the TV 24 and various other audio/visual devices 26 and Internet Appliances 28 by an appropriate interface 30, which can be any suitable analog or digital interface. In one embodiment, interface 30 conforms to an interface standard such as the Institute of Electrical and Electronics Engineers (IEEE) 1394 standard. The STB 22 may include a central processing unit (CPU) and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g. using a cable modem) to, thus, provide access to services and content from the ISP and the Internet. The ISP host 38 provides various content to the user that is obtained from a content database 52. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

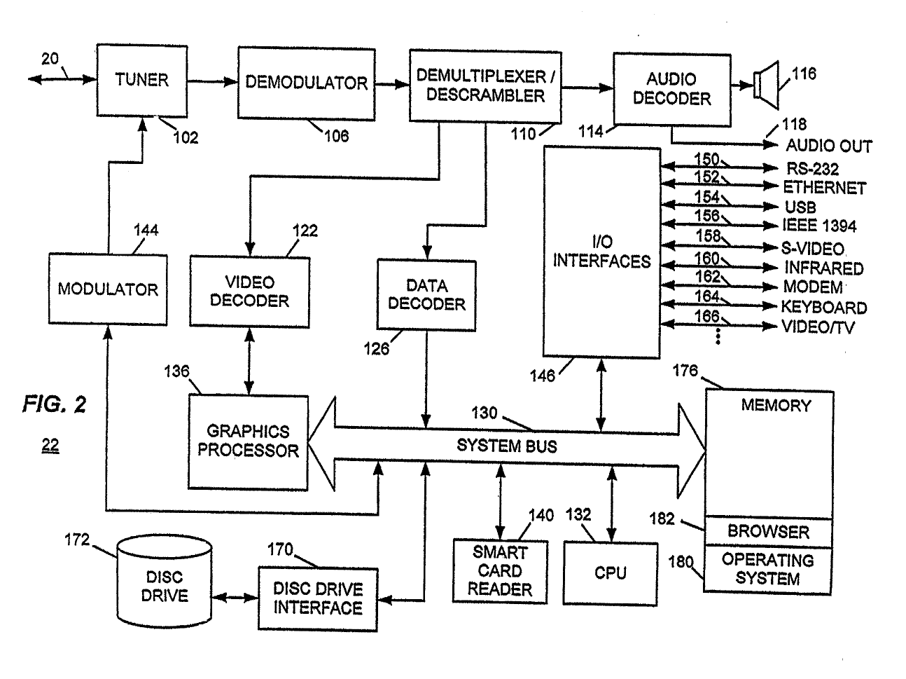

Referring now to FIG. 2, a typical system configuration for a digital set-top box 22 is illustrated. In this exemplary set-top box, the transmission medium 20, such as a coaxial cable, is coupled by a suitable interface to a tuner 102. Tuner 102 may, for example, include a broadcast in-band tuner for receiving content, an out-of-band tuner for receiving data transmissions and a return path tuner for providing an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g. audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g. stereo or home theater multiple channel audio systems) or other audio system 116 (e.g. stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to process graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

STB 22 may incorporate a smart card reader 140 for communicating with a so called “smart card”, often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bi-directional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the tuner (operating as a return path OOB tuner) and out through the transmission medium 20. This capability is used to provide a mechanism for the STB 22 and/or its user to send information to the head end (e.g. service requests or changes, registration information, etc.) as well as to provide fast outbound communication with the Internet or other services provided at the head end to the end user.

Set-top box 22 may include any of a plurality of I/O (Input/Output) interfaces represented by 1/0 interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire or i-link) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bi-directional communication via the DOCSIS cable modem with the STB 22 being identified by an unique URL (Universal Resource Locator).

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exeplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 may include a disc drive interface 170 and disc drive mass storage 172 for user storage of content and data as well as providing storage of programs operating on CPU 132. STB 22 may also, include floppy disc drives, CD ROM drives, CD R/W drives, DVD drives, etc. CPU 132, in order to operate as a computer, is coupled through the system bus 130 to memory 176. Memory 178 may include a combination of any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention.

In general during operation of the STB 22, an appropriate operating system 180 such as Sony Corporation's Aperios™ real time operating system is loaded into, or is permanently stored in, active memory along with the appropriate drivers for communication with the various interfaces. Along with the operating system and associated drivers, the STB 22 usually operates using browser software 182 in active memory or may permanently reside in ROM or EEPROM. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all may include at the lowest layer various hardware interface layers. Next is an operating system layer as previously described. The software architectures of the STB may include a next layer referred to as “middleware”. Such middleware permits applications to run on multiple platforms with little regard for the actual operating system in place. Middleware standards may be based upon JavaScript and HTML (HyperText Markup Language) virtual machines. At the top layer is the application layer where user applications and the like reside (e.g. browsing, email, EPG, Video On Demand (VOD), rich multimedia applications, pay per view, etc.). The current invention can be utilized with any suitable set-top box software architecture.

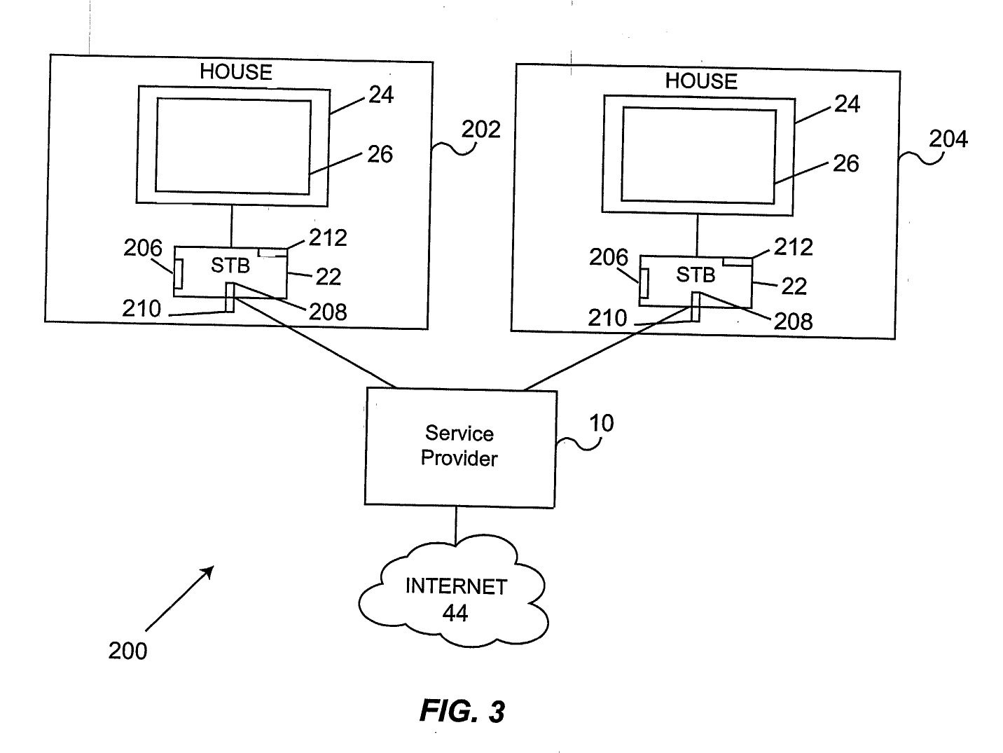

FIG. 3 illustrates a system 200 for a providing a display of items pertaining to a user. Such items may include a television program or programs watched by a user, television program or programs to be watched by the user, an activity or activities in which the user has participated, an activity or activities the user is scheduled to participated, radio programs listened to by the user, radio programs to be listened to by the user, and so forth.

As shown in FIG. 3, the system 200 may include a number of display arrangements 202 each located in a respective home, office or the like. Each display arrangement 202 may include STB 22 and a television 24 having a display 26 which may be arranged in a manner as previously described. Further, each STB 22 may be connected to service provider 10, the Internet 44 and/or remote server 48 (FIG. 1) in a manner as previously described. Additionally, each STB 22 may include an input device 206, a viewer recognition circuit 208 coupled to a camera 210, a timer 212, and a processor such as CPU 132 (FIG. 2).

The input device 206, which may be a keyboard or the like, is adapted to receive inputs from a user. Such inputs may include instructional commands pertaining to the set-up of the system 200, viewer information, a television program or programs a viewer or viewers has watched or will watch, the addition of comments which may be added to a display as hereinafter more fully described, and so forth.

The viewer recognition circuit 208, which may be coupled to the CPU 132 and which may utilize the CPU 132, is adapted to receive video inputs from the camera 210 and determine therefrom which person or persons are currently watching a television program. More specifically, the viewer recognition circuit 208 may initially receive a video input image or signature from each potential viewer in a home or office and may store the same in a memory such as memory 176 (FIG. 2). Thereafter, when the respective display arrangement 202 is activated, the camera 210 may automatically capture a video image of the person or persons currently watching the television 24 and may supply the same to the viewer recognition circuit 208, whereupon a comparison may be made between such captured image(s) and the stored signatures. Upon determination of a match, the viewer recognition circuit 208 may supply the identity of the person(s) currently watching the television 24 to the CPU 132. The viewer recognition circuit 208 may constantly monitor the identity of the person(s) watching the television 24 in a similar manner and may supply such identity information to the CPU 132.

In the event that the viewer recognition circuit 208 is unable to properly recognize a viewer, or in the event that the viewer recognition circuit is not included in a STB 22, information pertaining to the identity of the person or persons currently watching the television 24 may be manually inputted by the respective person(s) by use of the input device 206 and supplied to the CPU 132. Additionally, such person or persons may also input information pertaining to the television programs which they are watching or have watched by use of the input device 206 which may be supplied to the CPU 132.

The CPU 132 may receive information pertaining to the identity of the person(s) watching the television 24 from the viewer recognition circuit 208 or the input device 206, in a manner as previously described. The CPU 132 may also receive information pertaining to the amount of time a respective channel was “on” by use of timer 212, and information pertaining to each television program that was broadcast and received through the STB 22. Based upon such information, the CPU 132 may generate a television program signal which is representative of each television program each person watched and arranged in a predetermined manner. Such television program signal may be supplied to the television 24 in a respective home or office associated with the respective STB by way of the interface 30 or to a number of other televisions 24 associated with other STBs located at other homes or offices by way of the service provider 10 and Internet 44, whereupon a corresponding display may be presented on the respective display unit(s) 26.

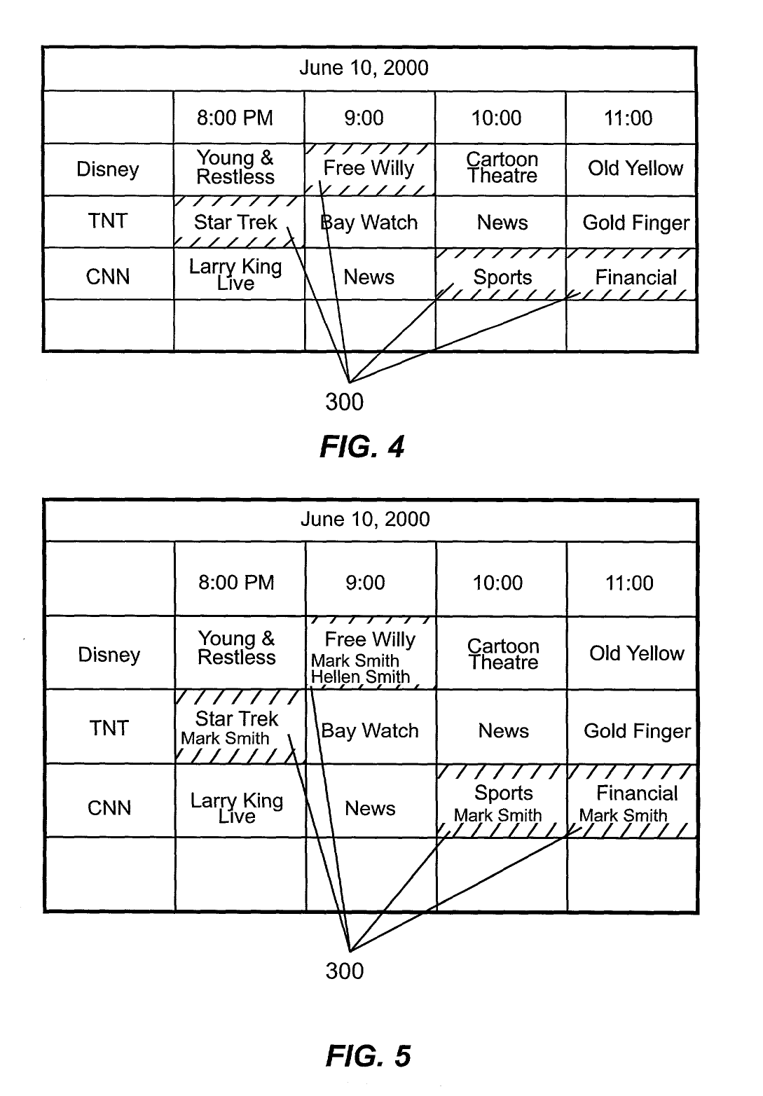

Examples of the above-described television program display are illustrated in FIGS. 4 and 5. As shown therein, the displays illustrate a plurality of television which were broadcasted along with highlighted programs 300 which represent the television programs watched by a respective viewer (FIG. 4) and viewers (FIG. 5). As is to be appreciated, although only the three channels which the viewer(s) watched between the hours indicated are illustrated in FIG. 4, the present invention is not so limited. Instead, other arrangements may also be utilized. For example, all television programs broadcasted between the desired hours may be displayed along with an indication (e.g., by highlighting) of the programs watched by the viewer(s).

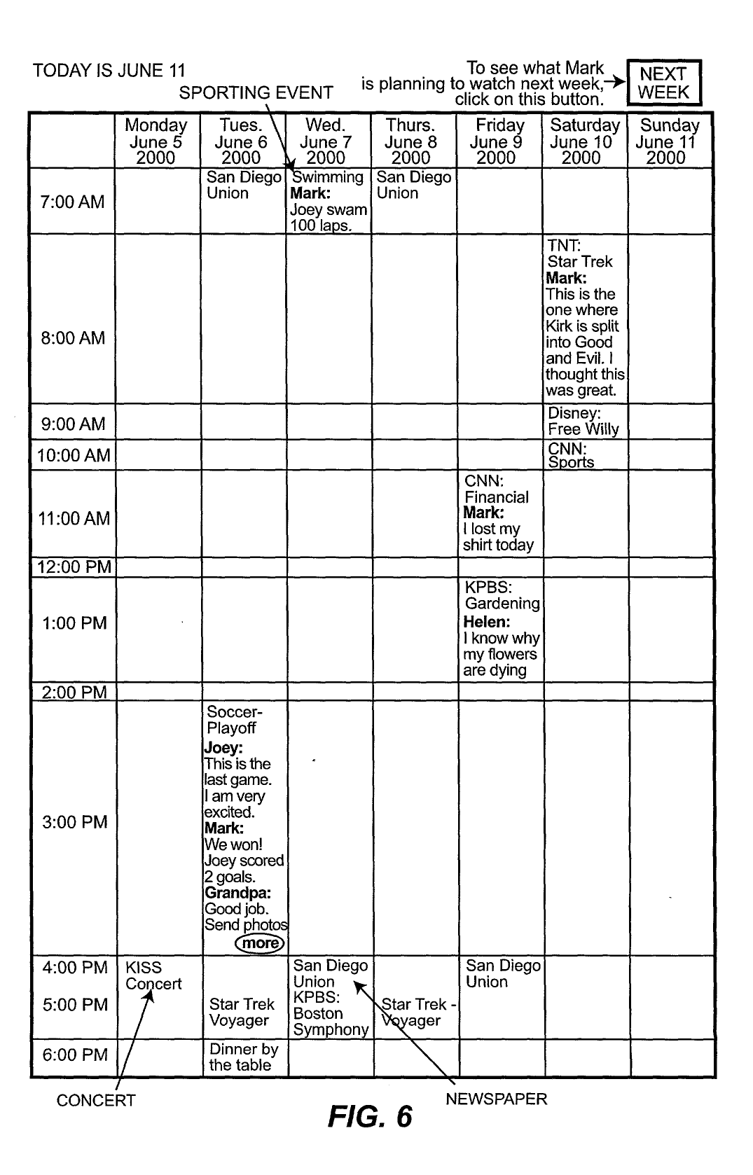

Additionally, a viewer or viewers may insert comments into a television program display. These comments may include comments pertaining to a particular program or to non-television program related items such as activities in which the viewer may have participated or will participate, and so forth. Such comments may be inputted by use of the input device 206, whereupon a signal may be supplied to the CPU 132 which, in turn, may generate a corresponding signal which may modify or be combined with the television program signal. An example of such a display is illustrated in FIG. 6. Further, a display may also be created which illustrates activities and/or television programs which a person(s) may participate in and/or watch in the future, as indicated in FIG. 6.

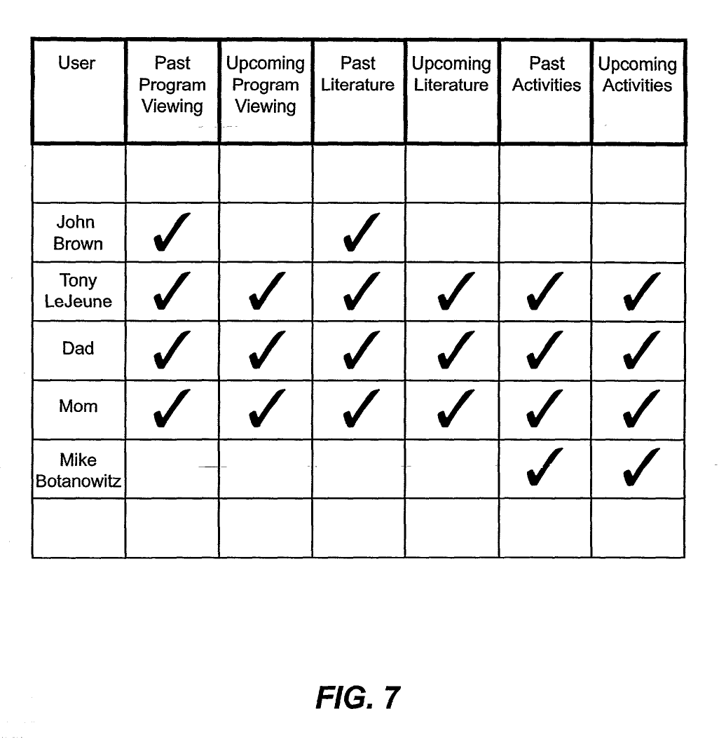

As indicated above, the present displays may be generated and displayed in the same home or office 202 or, alternatively, the displays may be generated and displayed in more than one home or office 202. In this latter situation, a group of people in a plurality of homes or offices may be established. Such group may be established by use of the input device 206 and destination address information (such as URL) pertaining to each respective STB 22 of the group. Further, each member within the group may be entitled to a different privilege or level of access with regard to the display. For example, as illustrated in FIG. 7, some members may be able to do one or more of viewing past programs, viewing upcoming programs, viewing past activities, and viewing upcoming activities. Additionally, some members may be able to add comments and/or edit material contained in a display.

Although the above displays were described as pertaining to television programs and/or activities, the present invention is not so limited. Instead, the present invention may be applied to other types of items. For example, the present invention may provide an indication of literature which a user read or will read, radio programs a user listened to or will listen to, and so forth.

As is to be appreciated, the present invention provides a means wherein parent may monitor the television programs their children watch. Further, the present invention provides a means wherein people within a household or a group within a plurality of households may easily notify others of day to day events such as television programs they watched or are planning to watch, activities such as sporting events and the like in which they have participated or are scheduled to participate, and so forth.

Although preferred embodiments of the present invention and modifications thereof have been described in detail herein, it is to be understood that this invention is not limited to these embodiments and modifications, and that other modifications and variations may be effected by one skilled in the art without departing from the spirit and scope of the invention as defined by the appended claims.

What is claimed is:

1. A television program apparatus comprising:
means for obtaining information regarding a number of television programs watched by a viewer;
means for producing a viewer program signal from the obtained information representative of each television program watched by the viewer arranged in a predetermined manner; and
means adapted to be coupled to a television unit for enabling said viewer program signal to be supplied to said television unit so as to enable an indication of each said television program watched by the viewer to be displayed thereon in said predetermined manner.

2. A television program apparatus according to claim 1, further comprising means for enabling comments to be inserted into the television program display.

3. A television program apparatus according to claim 1, wherein the means for obtaining information includes viewer recognition means for recognizing the viewer.

4. A television program apparatus comprising:
means for obtaining information regarding a number of television programs watched by a viewer;
means for producing a viewer program signal from the obtained information representative of each television program watched by the viewer arranged in a predetermined manner; and
means for enabling said viewer program signal to be supplied to a television unit located at a location remote from the television program apparatus so as to enable an indication of each said television program watched by the viewer to be displayed thereon in said predetermined manner.

5. A television program apparatus according to claim 4, further comprising means for enabling comments to be inserted into the television program display.

6. A television program apparatus according to claim 4, wherein the means for obtaining information includes viewer recognition means for recognizing the viewer.

7. An apparatus for providing indications of items pertaining to a user, said apparatus comprising:
means for obtaining information regarding at least one of a television program or programs watched by the user, television program or programs to be watched by the user, an activity or activities in which the user has participated, and an activity or activities the user is scheduled to participated;
means for producing a program/activity signal representative of each television program or activity arranged in a predetermined manner; and
means for enabling said program/activity signal to be supplied to at least one television unit located at a location remote from the apparatus so as to enable an indication of each said television program and activity to be displayed thereon in said predetermined manner.

8. An apparatus according to claim 7, further comprising means for enabling comments to be inserted into the television program or activity display.

9. An apparatus according to claim 7, wherein the means for obtaining information includes recognition means for recognizing the user.

10. A television program method comprising the steps of:
obtaining information regarding a number of television programs watched by a viewer;
producing a viewer program signal from the obtained information representative of each television program watched by the viewer arranged in a predetermined manner; and
enabling said viewer program signal to be supplied to a television unit so as to enable an indication of each said television program watched by the viewer to be displayed thereon in said predetermined manner.

11. A television program method according to claim 10, further comprising the step of enabling comments to be inserted into the television program display.

12. A television program method according to claim 10, wherein the obtaining step includes recognizing the viewer by use of a viewer recognition device.

13. A television program method comprising the steps of:
obtaining information regarding a number of television programs watched by a viewer;
producing a viewer program signal from the obtained information representative of each television program watched by the viewer arranged in a predetermined manner; and
enabling said viewer program signal to be supplied to a television unit located at a remote location so as to enable an indication of each said television program watched by the viewer to be displayed thereon in said predetermined manner.

14. A television program method according to claim 13, further comprising the step of enabling comments to be inserted into the television program display.

15. A television program method according to claim 13, wherein the obtaining step includes recognizing the viewer by use of a viewer recognition device.

16. A method for providing indications of items pertaining to a user, said method comprising the steps of:
obtaining information regarding at least one of a television program or programs watched by the user, television program or programs to be watched by the user, an activity or activities in which the user has participated, and an activity or activities the user is scheduled to participate;
producing a program/activity signal representative of each television program or activity arranged in a predetermined manner; and
enabling said program/activity signal to be supplied to at least one television unit located at a remote location so as to enable an indication of each said television program and activity to be displayed thereon in said predetermined manner.

17. A method according to claim 16, further comprising the step of enabling comments to be inserted into the television program or activity display.

18. A method according to claim 16, wherein the obtaining step includes recognizing the user by use of a recognition device.

19. A television program apparatus comprising:
means for obtaining information regarding a number of television programs watched by at least one viewer;
means for producing a television program signal representative of a plurality of broadcasted television programs arranged in a predetermined manner in which each television program watched by each viewer is indicated therein; and
means for enabling said television program signal to be supplied to a television unit so as to enable the plurality of broadcasted television programs along with an indication of each said television program watched by each said viewer to be displayed thereon in said predetermined manner.

20. A television program apparatus according to claim 19, further comprising means for enabling comments to be inserted into the television program display.

21. A television program apparatus according to claim 19, wherein the means for obtaining information includes viewer recognition means for recognizing the viewer.

22. A television program apparatus according to claim 19, wherein the obtaining means obtains information regarding a number of television programs watched by more than one viewer.

23. A television program method comprising the steps of:
obtaining information regarding a number of television programs watched by at least one viewer;
producing a television program signal representative of a plurality of broadcasted television programs arranged in a predetermined manner in which each television program watched by each viewer is indicated therein; and
enabling said television program signal to be supplied to a television unit so as to enable the plurality of broadcasted television programs along with an indication of each said television program watched by each said viewer to be displayed thereon in said predetermined manner.

24. A television program method according to claim 23, further comprising the step of enabling comments to be inserted into the television program display.

25. A television program method according to claim 23, wherein the obtaining step includes recognizing the viewer by use of a viewer recognition device.

26. A television program method according to claim 23, wherein the obtaining step obtains information regarding a number of television programs watched by more than one viewer.

27. A television program apparatus comprising:
an input device which obtains information regarding a number of television programs watched by a viewer;
a processor arranged to receive the obtained information from the input device which produces a viewer program signal from the received information representative of each television program watched by the viewer arranged in a predetermined manner; and
an output interface which enables said viewer program signal to be supplied to a television unit so as to enable an indication of each said television program watched by the viewer to be displayed thereon in said predetermined manner.

28. A television program apparatus according to claim 27, further comprising a viewer input device which enables comments to be inserted into the television program display.

29. A television program apparatus according to claim 27, wherein the input device includes a viewer recognition circuit which recognizes the viewer.

30. An apparatus for providing indications of items pertaining to a user, said apparatus comprising:
an input device which obtains information regarding at least one of a television program or programs watched by the user, television program or programs to be watched by the user, an activity or activities in which the user has participated, and an activity or activities the user is scheduled to participated;
a processor arranged to receive the obtained information from the input device which produces a program/activity signal representative of each television program or activity arranged in a predetermined manner; and
an output interface which enables said program/activity signal to be supplied to at least one television unit so as to enable an indication of each said television program and activity to be displayed thereon in said predetermined manner.

31. An apparatus according to claim 30, further comprising a user input device which enables comments to be inserted into the television program or activity display.

32. An apparatus according to claim 30, wherein the input device includes a recognition circuit which recognizes the user.

33. A television program apparatus comprising:
an input device which obtains information regarding a number of television programs watched by at least one viewer;
a processor arranged to receive the obtained information from the input device which produces a television program signal representative of a plurality of broadcasted television programs arranged in a predetermined manner in which each television program watched by each viewer is indicated therein; and
an output interface which enables said television program signal to be supplied to a television unit so as to enable the plurality of broadcasted television programs along with an indication of each said television program watched by each said viewer to be displayed thereon in said predetermined manner.

34. A television program apparatus according to claim 33, further comprising a viewer input device which enables comments to be inserted into the television program display.

35. A television program apparatus according to claim 33, wherein the input device includes a viewer recognition circuit which recognizes the viewer.

36. A television program apparatus according to claim 33, wherein the input device obtains information regarding a number of television programs watched by more than one viewer.

37. A system having a plurality of apparatuses arranged so as to communicate with each other and each adapted to be coupled to a display device for providing a display of items pertaining to at least one user, each apparatus comprising:
an input device which obtains information regarding at least one of a television program or programs watched by a user, television program or programs to be watched by the user, an activity or activities in which the user has participated, and an activity or activities the user is scheduled to participated;
a processor arranged to receive the obtained information from the input device which produces a program/activity signal representative of each television program or activity arranged in a predetermined manner; and
an output interface which enables said program/activity signal to be supplied to a display device coupled to the respective apparatus and to another apparatus having another display device coupled thereto so as to enable an indication of each said television program and activity to be displayed thereon in said predetermined manner.

38. A system according to claim 37, wherein each apparatus further comprises a user input device which enables comments to be inserted into the television program or activity display.

39. A system having a plurality of apparatuses arranged so as to communicate with each other and each adapted to be coupled to a display device for providing a display of items pertaining to at least one viewer, each apparatus comprising:
an input device which obtains information regarding a number of television programs watched by at least one viewer;
a processor arranged to receive the obtained information from the input device which produces a television program signal representative of a plurality of broadcasted television programs arranged in a predetermined manner in which each television program watched by each viewer is indicated therein; and
an output interface which enables said television program signal to be supplied to a display device coupled to the respective apparatus and to another apparatus having another display device coupled thereto so as to enable the plurality of broadcasted television programs along with an indication of each said television program watched by each said viewer to be displayed thereon in said predetermined manner.

40. A system according to claim 39, wherein each apparatus further comprises a user input device which enables comments to be inserted into the television program or activity display.
